(19) United States
(12) Patent Application Publication
(10) Pub. No.: US 2008/0240963 A1
(43) Pub. Date: Oct. 2, 2008

(54) ROTOR SHAFT SEALING STRUCTURE FOR OIL-FREE ROTARY COMPRESSOR

(75) Inventors: Hideyuki KIMURA, Kawasaki-city (JP); Masami MUTO, Yokohama-city (JP)

Correspondence Address: ROSSI, KIMMS & McDOWELL LLP., P.O. BOX 826, ASHBURN, VA, 20146-0826, US

(73) Assignee: ANEST IWATA CORPORATION, Yokohama-shi (JP)

(21) Appl. No.: 12/058,821

(22) Filed: Mar. 31, 2008

(30) Foreign Application Priority Data
Mar. 30, 2007 (JP) 2007-95582

(51) Int. Cl. F04C 27/00; F01C 19/00; F16J 15/16

(52) U.S. Cl. 418/104; 277/500; 277/409

(57) ABSTRACT

A rotor shaft sealing structure of an oil-free rotary compressor is provided, with which is reduced a risk of occurrence of lubrication oil intrusion into the compression chamber (9) of the compressor which is liable to occur when negative pressure is produced in the compression chamber (9). The rotor shaft sealing structure is composed such that two shaft seal means (20, 30) are provided in the rotor casing (1) between the oil lubricated bearing (10, 10′) and the compression chamber (9) such that an annular airspace (24) is formed between the two shaft seal means (20,31), at least one communicating hole (34,34′) is provided to communicate the annular airspace (24) to the outside of the rotor casing (1), and the annular airspace (24) of the male rotor shaft (6) sealing part and the annular airspace (24) of the female rotor shaft (7) sealing part are connected by a between-rotor shaft communication passage (35).

### BACKGROUND OF THE INVENTION

1. Field of the Invention

The present invention relates to a rotor shaft sealing structure of an oil-free rotary compressor such as a tooth type rotary compressor, with which sealing structure can prevent lubrication oil of the drive mechanism of the compressor rotors from leaking into the compression chamber of the compressor even when the pressure of the compression chamber becomes lower than atmospheric pressure, which occurs under some operation condition of the compressor.

2. Description of the Related Art

Generally, a tooth type rotary compressor consists of two rotors, a male rotor and a female rotor, each having claw-like teeth, or lobes. The rotors turn in opposite directions without contact to each other to compress gas trapped in the compression pockets formed between the lobes and inner surface of a compressor casing as the rotors rotate. As the rotors do not contact with each other and with the inner surface of the compressor casing, the rotors do not wear and have a long life. Further, lubrication of the rotors is not needed because of non-contact engagement of the rotors, and clean compressed gas not contaminated with lubricant can be obtained. Compression ratio obtained by this type of compressor is relatively low, and required high compression ratio is obtained with high efficiency in many cases by composing a two-stage compressor unit comprised of a lower pressure stage compressor and a higher pressure stage compressor connected in series and driven separately. Working of the tooth type compressor will be explained hereunder referring to FIG. 5a to FIG. 5d

In FIG. 5a, a male rotor 02 having claw-like lobes engages with a female rotor 03 having claw-like lobes with very tight clearances in a compressor housing 01. Gas g to be compressed is sucked from a suction opening 04 into the compressing chamber as the rotors 02 and 03 rotate in directions indicated by arrows. In FIG. 5b, the suction opening 04 is closed by the rotors 02, 03, and the sucked gas g is confined in a pocket surrounding the lobes of the female rotor 03 and in a pocket surrounding the lobes of the male rotor 02. The rotors convey the gases confined, or trapped in the pockets from the suction side to the pressure side as shown in FIG. 5c, where the pockets are communicated and the volume of the sum of the two pockets reduces as the rotors rotate and the gases are compressed until the female rotor 03 uncovers the discharge port 05. In FIG. 5d, the discharge port 05 is uncovered by the female rotor 03 and the compressed gas c between the rotors is discharged through the discharge port 05.

It is necessary requirement for an oil-free rotary compressor such as an oil-free tooth type compressor that lubrication oil for lubricating rotor shaft bearings is prevented from leaking into the compression chamber of the compressor in order to supply clean compressed gas not containing the lubrication oil. Positive pressure is produced in the compression chamber in load operation of the compressor, but when the compressor is operated under no load, pressure in the compression chamber becomes negative, for the upstream side of the suction port of the compressor is shut by a suction closing mechanism. When pressure in the compression chamber becomes negative, intrusion of lubrication oil supplied to the rotor bearing into the compression chamber through the shaft seal may occur.

Rotor shaft sealing structure of a screw compressor type supercharger is disclosed in Japanese Laid-Open Utility Model Application No. 3-110138 (patent literature 1). The sealing structure is composed such that a lip seal (contact seal) and a non-contact seal are located between rotor shaft bearing and the compression chamber, an airspace is formed between both the seals, a communicating passage is provided to allow the airspace to communicate with outside air, and a check valve is provided in the communicating passage to allow outside air to be sucked into the airspace when negative pressure is produced in the airspace.

With the construction, pressure difference between the compression chamber and the airspace is reduced through the non-contact seal having fin-like annular protrusions such as a labyrinth seal. When pressure in the compression chamber is positive, higher than atmospheric pressure, escaping of the positive pressure air in the compression chamber passing through the communicating passage is prevented by the check valve closed by positive pressure in the communicating passage, and when pressure in the compression chamber is negative, the check valve is opened by negative pressure in the communicating passage and outside air is sucked into the air space, thus the airspace serves as a pressure equalizer room. In this way, intrusion of the lubrication oil into the compression chamber is prevented by maintaining the airspace not lower in pressure than that in the bearing part.

A rotor shaft sealing structure disclosed in Japanese Laid-Open Patent Application No. 7-317553 (patent literature 2) relates also to shaft sealing structure of a screw compressor type supercharger. The shaft sealing structure is composed such that a contact seal (lip seal, for example) for sealing lubrication oil lubricating the rotor shaft bearing and a pressure fluctuation alleviating member (a piston ring movable in axial direction, for example) are located between rotor shaft bearing and the compression chamber, an airspace which serves as a pressure equalizer room is formed between the contact seal and the pressure fluctuation alleviating member, and a communicating passage opened into outside of the compressor.

However, with the sealing structure disclosed in the patent literature 1, in a case where leakage of lubrication oil occurs from the bearing part to the airspace through the lip seal, the oil leaked to the airspace is difficult to escape outside because of the presence of the check valve in the communicating passage. When pressure in the compression chamber becomes negative while the leaked lubrication oil is present in the airspace, the lubrication oil residing in the airspace is apt to be ingested into the compression chamber.

Further, in a case where the communicating passage is clogged from any cause, the leaked lubrication oil accumulates in the airspace without being allowed to escape outside, and the leaked lubrication oil accumulated in the airspace is easily ingested into the compression chamber when negative pressure is produced in the compression chamber.

According to the sealing structure disclosed in the patent literature 2, the communicating passage for communicating the airspace surrounding the rotor shaft to the outside of the compressor is not provided with a check valve. However, a means for allowing lubrication oil leaked into the airspace to escape outside in a convincing way is not disclosed also in the patent literature 2. Further, a means for allowing lubrication oil accumulated in the airspace when the communicating passage is clogged from any cause to escape outside is not disclosed in the patent literature 2 as is not disclosed in the patent literature 1.

### SUMMARY OF THE INVENTION

The present invention was made in light of the problems of the prior arts, and the object of the invention is to provide a rotor shaft sealing structure of an oil-free rotary compressor, with which a risk of occurrence of lubrication oil intrusion into the compression chamber of the compressor which is liable to occur when negative pressure is produced in the compression chamber, is reduced, and even if lubrication oil leaks through the bearing side oil seal toward the annular airspace, the leaked lubrication oil is exhausted smoothly to the outside of the compressor casing and prevented from intruding into the compression chamber.

To attain the object, the present invention proposes a rotor shaft sealing structure of an oil-free rotary compressor having a pair of male and female rotors accommodated in a compression chamber formed by a rotor casing, each rotor having a rotor shaft extending vertically to penetrate both upper and lower walls of the rotor casing to be supported via oil lubricated bearings by both the upper and lower walls of the rotor casing, in which

a rotor shaft sealing part comprising two shaft seal means is provided to each of rotor shaft bearing parts between the bearing and the compression chamber such that a horizontal annular airspace is formed between the shaft seal means,

at least one communicating hole for communicating each horizontal annual airspace to the outside of the rotor casing is provided such that the communicating hole opens at the lower corner or the bottom face of the horizontal annular airspace and descends toward the outer periphery of the rotor casing to open to the outside thereof, and

each of the horizontal annular airspaces of the male rotor shaft sealing parts and each of those of the female rotor shaft sealing parts are connected by a between-rotor shaft communication passage respectively.

In the rotor shaft sealing structure, two seal means are provided between the bearing and compression chamber so that an annular airspace is formed in the seal means for maintaining a pressure outside the rotor casing which is atmospheric pressure or near atmospheric pressure by communicating the annular space to the outside of the rotor casing.

In load operation of the compressor, pressure in the compression chamber is higher than atmospheric pressure and compressed gas in the compression chamber may leak slightly toward the annular airspace through the shaft seal means located adjacent to the compression chamber. The leaked gas flows out through the communicating hole to the outside of the rotor casing. Therefore, even if lubrication oil leaks through the oil seal means located adjacent to the rotor shaft bearing to the annular airspace, the lubrication oil leaked to the annular airspace is taken away by the leaked gas to the outside of the rotor casing, and there is no fear that the lubrication oil intrudes into the compression chamber.

When the compressor is operated at no load, suction path of the compressor is shut-off and negative pressure is produced in the compressor chamber. Air in the annular airspace may be ingested through the sealing means located adjacent to the compression chamber thereinto. However, the annular airspace is communicated to the outside of the rotor casing and maintained at atmospheric pressure, so there is little fear that lubrication oil leaks through the shaft seal means located adjacent to the bearing and intrudes into the combustion chamber.

According to the embodiment, by providing at least one communicating hole for every annular airspace to communicate to the outside of the rotor casing, the annular airspace is always maintained at atmospheric pressure and a risk of intrusion of lubrication oil into the compression chamber can be reduced.

In the embodiment, the communicating hole for communicating each horizontal annual airspace to the outside of the rotor casing is provided such that it opens at the lower corner or the bottom face of the horizontal annular airspace and descends toward the outer periphery of the rotor casing to open to the outside thereof. Therefore, even if lubrication oil leaks to the annular airspace, it is easily exhausted through the communication hole to the outside of the rotor. Therefore, leaked lubrication oil does not accumulate in the annular airspace and a risk of intrusion of lubrication oil into the compression chamber can be reduced.

Further, as the horizontal annular airspace of the male rotor shaft sealing part and that of the female rotor shaft sealing part are connected by a between-rotor shaft communication passage, even when the communicating hole or holes of the rotor sealing part of one of the rotor shafts are clogged by any cause, lubrication oil leaked for example to the male rotor shaft side annular airspace can be exhausted through the between-rotor shaft communication passage connecting the male rotor shaft side annular airspace to the female rotor side annular airspace and through the female rotor side communicating hole or holes to the outside of the rotor casing.

By composing the rotor sealing part such that a contact seal is located adjacent to the compression chamber and a non-contact seal located adjacent to the bearing to form the horizontal annular airspace between them, driving power loss due to friction between the shaft seal means and rotor shaft can be reduced.

It is preferable that the contact seal is a carbon ring type seal and said non-contact seal is a viscoseal which works to force back lubrication oil from the bearing toward the bearing through the rotation of the rotor shaft. Sealing effect of gas in the compression chamber can be increased by the carbon ring type seal and lubrication oil leak from the bearing side can be effectively prevented by the viscoseal.

It is suitable that at least one communicating hole larger in diameter than that of said communication hole is further provided to at least one of the horizontal annular airspaces such that the communicating hole of larger diameter opens in the horizontal annular airspace and descends toward the outer periphery of the rotor casing to open to the outside thereof. Even when the communicating holes smaller in diameter clogs by any cause, this communicating hole larger in diameter works to communicate the annular airspace to the outside of the rotor casing and to exhaust lubrication oil leaked to the annular air space when leaked to the outside of the rotor casing.

The invention proposes for a case the compressor is installed horizontally, that is, the rotor shafts extend horizontally, a rotor shaft sealing structure of an oil-free rotary compressor having a pair of male and female rotors accommodated in a compression chamber formed by a rotor casing, each rotor having a rotor shaft extending horizontally from both right and left side faces of the rotor and penetrating both right and left side walls of the rotor casing to be supported via oil lubricated bearings by both the right and left side walls of the rotor casing, in which

a rotor shaft sealing part comprising two shaft seal means is provided to each of rotor shaft bearing parts between the bearing and the compression chamber such that a vertical annular airspace is formed between the seal means, the shaft seal means being a viscoseal located adjacent the bearing and a contact seal located adjacent the compression chamber,

at least one communicating hole is provided to communicate the vertical annular airspace so that lubrication oil leaked to the annular airspace flows down by gravity to the outside of the rotor casing, and

each of the vertical annular airspaces of the male rotor shaft sealing parts and each of those of the female rotor shaft sealing parts are connected by a connecting passage respectively.

It is suitable that at least one communicating hole larger in diameter than that of said communication hole is further provided to at least one of the vertical annular airspaces such that the communicating hole of larger diameter opens in the vertical annular airspace and descends toward the outer periphery of the rotor casing to open to the outside thereof. Even when the communicating holes smaller in diameter clogs by any cause, this communicating hole larger in diameter works to communicate the annular airspace to the outside of the rotor casing and to exhaust lubrication oil leaked to the annular air space when leaked to the outside of the rotor casing.

According to the shaft sealing structure of the invention, as at least one communicating hole is provided for every annular airspace to communicate to the outside of the rotor casing, the annular airspace is always maintained at atmospheric pressure and a risk of intrusion of lubrication oil into the compression chamber can be reduced even when negative pressure is produced in the compression chamber. Further, as the horizontal annular airspace of the male rotor shaft sealing part and that of the female rotor shaft sealing part are connected by a connecting passage, even when the communicating hole or holes of the rotor sealing part of one of the rotor shafts are clogged by any cause, its annular airspace is communicated to the outside of the rotor casing via the between-rotor shaft communication passage and communicating hole or holes of the rotor sealing part of other rotor shaft and lubrication oil leaked to the annular airspace can be exhausted without fail to the outside of the rotor casing.

### BRIEF DESCRIPTION OF THE DRAWINGS

FIG. 1 is a longitudinal sectional view of a rotary compressor where sealing structure of the invention is adopted to the rotor shafts.

FIG. 2 is a partially enlarged section of FIG. 1.

FIG. 3 is an enlarged sectional view of the viscoseal part of FIG. 1.

FIG. 4 is a sectional view along the line A-A in FIG. 1.

FIG. 5a to FIG. 5d are drawings for explaining working of a tooth type rotary compressor.

### DETAILED DESCRIPTION OF THE PREFERRED EMBODIMENTS

A preferred embodiment of the present invention will now be detailed with reference to the accompanying drawings. It is intended, however, that unless particularly specified, dimensions, materials, relative positions and so forth of the constituent parts in the embodiments shall be interpreted as illustrative only not as limitative of the scope of the present invention.

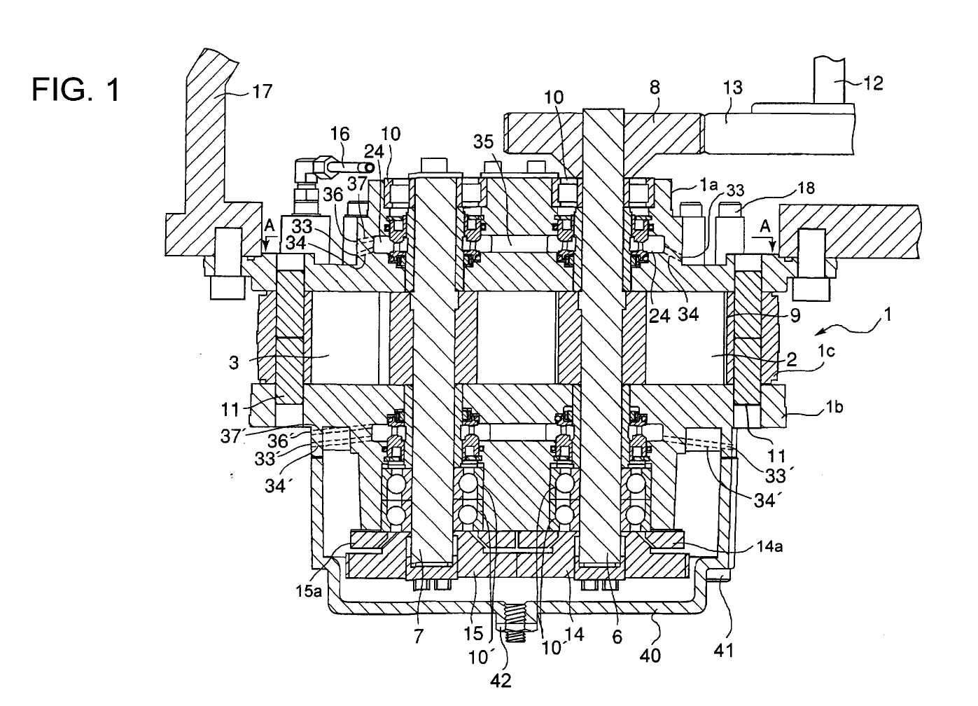

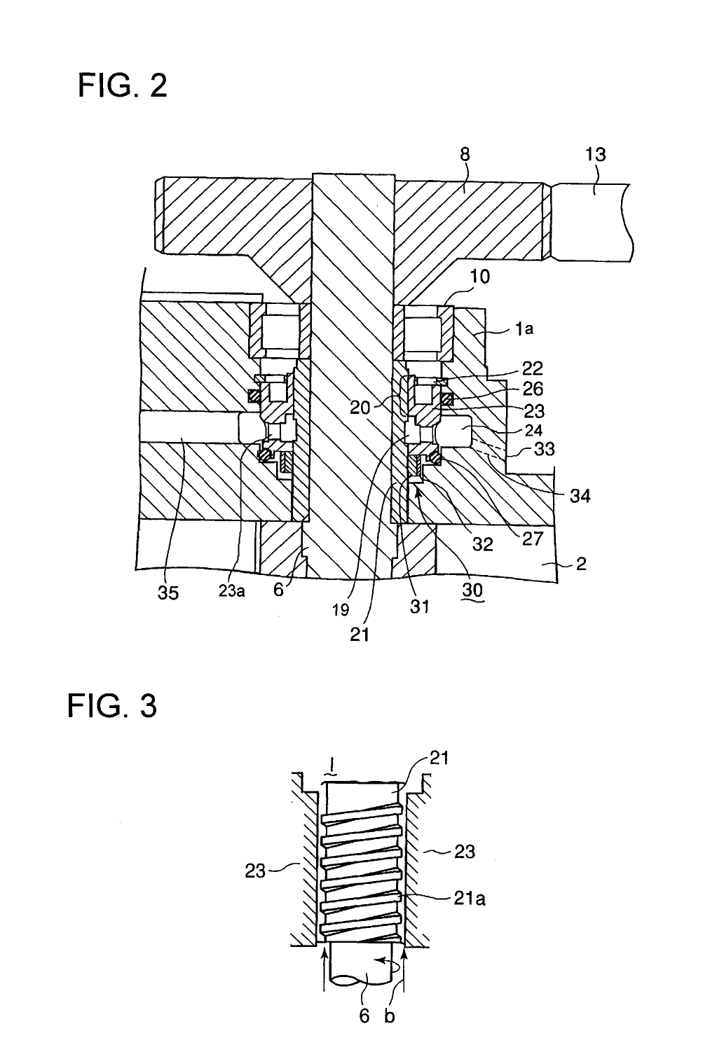

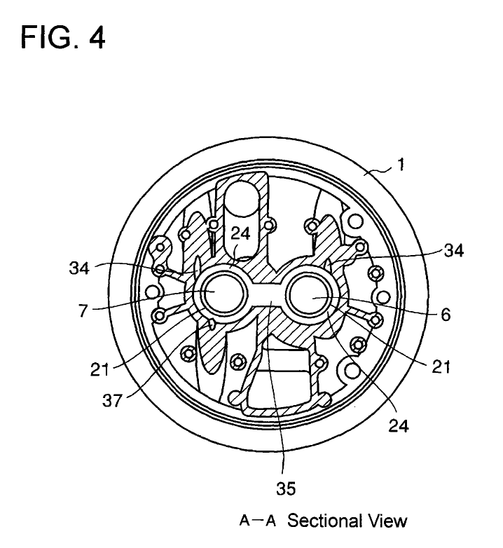

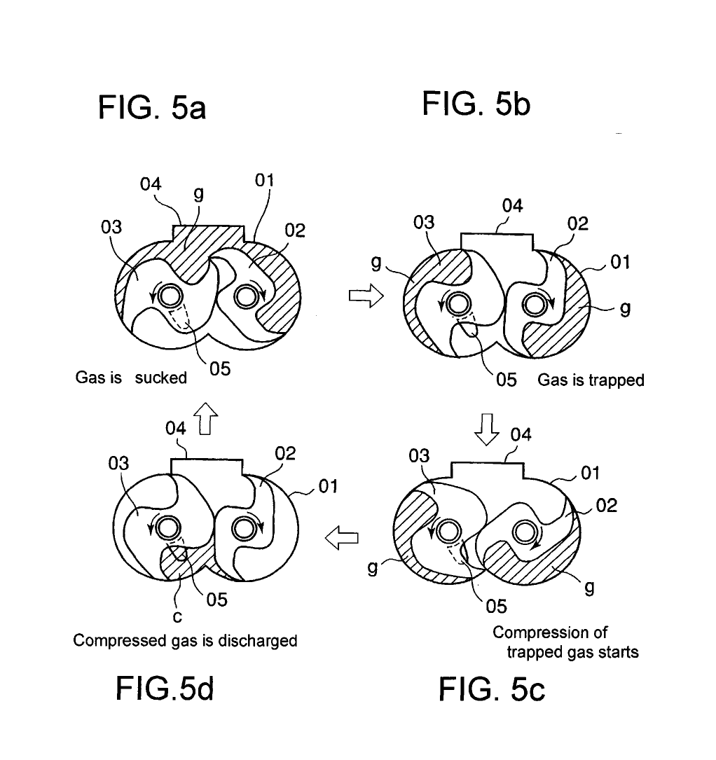

An embodiment of the invention will be explained with reference to FIGS. 1 to 4. FIG. 1 is a longitudinal sectional view of a tooth type rotary compressor where sealing structure of the invention is adopted to the rotor shaft FIG. 2 is a partially enlarged section of FIG. 1, FIG. 3 is an enlarged sectional view of the viscoseal part of FIG. 1, and FIG. 4 is a sectional view along the line A-A in FIG. 1.

Referring to FIG. 1, a male rotor 2 and a female rotor 3 are accommodated in a compression chamber 9 formed in a rotor casing 1 which is composed of an upper casing member 1a, a lower casing member 1b, and an intermediate casing member 1c. They are center-aligned with dowel pins 11 and connected together by means of bolts 18. The male rotor 2 and female rotor 3 are respectively fixed to a male rotor shaft 6 and a female rotor shaft 7 supported rotatably by the upper and lower casing members 1a and 1b via bearings 10 and bearings 10′. Reference numerals 14a and 15a are cover plates for holding bearings 10′.

A gear 8 is fixed to one end of the male shaft 6. The gear 8 meshes with a gear 13 fixed to a rotation shaft 12 of an electric motor not shown in the drawing so that the male rotor 2 is driven by the electric motor. Timing gears 14 and 15 are attached to the lower end of the male rotor shaft 6 and the female rotor shafts 7 respectively so that both the rotors are rotated in synchronization in counter directions at the same rotation speed. The timing gears 14 and 15 are covered by a cover 40 bolted by bolts 41 to the lower casing member 1b, and a connector 42 is attached to the bottom of the cover 40 to connect a drain pipe for oil draining.

Another tooth type rotary compressor not shown in the drawing is provided to the right of this tooth type rotary compressor and also driven the electric motor via the gear 13. These two rotary compressors constitute a two-stage compressor unit comprised of a low pressure stage compressor and a high pressure stage compressor connected in series to produce high compression pressure. The two compressors are driven by said single electric motor not shown in the drawing, and the gears 8, 13 are located in a driving gear room covered by a gear casing 17 attached to the upper casing member 1a. Lubrication oil is supplied via an oil supply pipe 16 to the bearings 10′ through oil passage not shown in the drawing and then flows out through gaps between the cover plates 14a, 15a and the timing gears 14, 15 to lubricate the teeth of the timing gears. The lubrication oil lubricated the bearings 10′ and timing gears 14, 15 and fell down to the bottom of the cover 40 is drained through the drain pipe connected to the connector 42 to an oil tank not shown in the drawing.

Lubrication oil supplied to lubricate the gears 8 and 12 and fell down to upper surface of the upper casing member 1a is also drained to said oil tank through drain path not shown in the drawing.

Next, shaft sealing structure of the male and female rotor shafts 6 and 7 will be explained referring to FIG. 2 showing the sealing structure of the bearing part 10 of the male rotor shaft 6 as a representative of the sealing structure. Sealing structure of the lower bearing parts 10′ is similar to that and explanation is omitted. Referring to FIG. 2, an inner sleeve 21 is inserted tightly on the male rotor 6 between the bearing 10 and the rotor side end face of the upper casing member 1a. An outer sleeve 23 is received in a bore of the casing member 1a such that the outer surface of the outer sleeve 23 is sealed with O-rings 26 and 27, and the O-rings also serve to prevent the outer sleeve 23 from rotating by friction force exerting between O-rings and the outer sleeve 23 and the bore of the upper casing member 1a. A circular groove is formed in the upper casing member 1a such that an annular airspace 24 is formed to surround the outer surface of the outer sleeve between the O-rings 26, 27. The outer sleeve 23 has an inner grove 19 which is communicated by radial holes 23a of the outer sleeve 23 to the annual airspace 24. The inner groove 19 and the annular airspace 24 are horizontal when the rotor shafts 6 is vertical, and the bottom face of the annular space 24 is positioned a little lower than the bottom face of the inner groove 19 and the radial holes 23a communicate the inner groove 19 to the annular airspace 24 such that lubrication intruded into the inner groove 19 does not accumulate in the inner groove 19 but flows to the annular airspace 24 by gravity. Reference numeral 22 is a snap ring for restricting axial movement of the outer sleeve 23.

A viscoseal zone is formed between the outer surface of the inner sleeve 21 and the inner surface of the outer sleeve 23 along a range indicated by reference numeral 20. Referring to FIG. 3, on the outer surface of the inner sleeve 21 is formed a thread 21a in the range 20 and the top face of the thread does not contact with the inner surface of the outer sleeve 23. Lubrication oil lubricated the bearing 10 fills the clearance between the thread 21a and the inner surface of the outer sleeve 23. The thread 21a is formed such that lubrication oil filled the clearance is pressurized by screw pump effect of the thread 21a and forced upward (in direction b) by the rotation of the male rotor shaft 6. By this action, lubrication oil I is prevented from intruding into the inner grove 19.

Viscoseal effect can be obtained by forming a female thread on the inner surface of the outer sleeve 23 instead of forming the male thread 21a on the outer surface of the inner sleeve 21.

A contact type shaft seal 30 composed of a ring-shaped carbon seal 31 an outer ring 32 made of metal is provided under the lower end of the outer sleeve 23. The inner grove 19 of the outer sleeve 23 is communicated through the radial holes 23a to the horizontal annular airspace 24 as mentioned before. A communication hole 34 for communicating the horizontal annual airspace 24 to outside is provided such that it opens at the lower corner of the horizontal annular airspace 24 and descends toward the outer periphery of the upper casing member 1a to open to the outside thereof as indicated by an opening end 33 which is located at a position lower than the inner groove 19 so that lubrication oil leaked through the viscoseal zone to the inner groove 19 flows down through the radial holes 23a and through the communication hole 34 into the gear room enclosed by the gear casing 17 and the upper casing member 1a.

As can be seen in FIG. 1 and FIG. 4, one communication hole 34 to communicate the annular airspace to the outside is provided for each of the annular airspaces 24 of the male and female rotor shaft sides, and further a between-rotor shaft communication passage 35 is provided in the upper casing member 1a to communicate the annular airspace 24 of the male rotor side to that of the female rotor side. The rotor shaft sealing structure at the under part of each of the male and female rotor shafts is similar to that of the above mentioned structure as can be seen in FIG. 1.

A communication hole 37 which is larger in diameter than that of the communication hole 34 is provided to communicate the annular airspace 24 of the female rotor shaft side to the outside such that the communicating hole 37 inclines downward as is the communication hole 34. Reference numeral 36 indicates the outside opening end of the communication hole 37. Even if the communication holes 34 are clogged by any cause, lubrication oil intruded into the inner groove 19 can be exhausted through the communication hole 37 to the outside of the upper casing member 1a in the driving gear room covered by the gear casing 17.

When the tooth type compressor is in load operation, pressure in the compression chamber is positive and higher than the pressure in the gear room enclosed by the gear casing 17 and the upper casing member 1a, and compressed gas may slightly leaks through the contact type shaft seal 30 toward the inner groove 19. As the viscoseal zone 20 is provided between the bearing 10 and the inner groove 19, lubrication oil intruded into the viscoseal zone 20 is forced upward by the rotation of the male rotor shaft 6 as mentioned above and does not leaks into the inner groove 19. Therefore, ingestion of lubrication oil into the compression chamber 9 does not occur.

When the tooth type compressor is in no-load operation, the suction path is shut off by a suction closing mechanism, however in practice slightly opened to allow gas to be slightly sucked, for if completely shut off there occurs abnormal noise.

Negative pressure is produced in the compression chamber 9 in no-load operation of the compressor. Therefore, there is fear that air is ingested from the inner groove 19 through the contact type shaft seal 30 to the compression chamber 9, which tends to reduce pressure in the inner groove 19 resulting in decreased oil seal effect of the viscoseal 20. According to the embodiment, the inner groove 19 is communicated to the outside of the upper casing member 1a where the pressure is near atmospheric through the radial holes 23a, annular airspace 24 and the communication hole 34, so the inner groove 19 is maintained always at that pressure, and sealing effect of the viscoseal 20 is always maintained when the compressor is operated. Therefore, ingestion of lubrication oil into the compression chamber 9 does not occur.

Lubrication oil may intrude into the inner groove 19 through the viscoseal 20 when operation of the compressor is stopped or rotation speed is low. The lubrication oil intruded into the inner groove 19 flows to the annular airspace 24 through the radial holes 23a of the outer sleeve 23 and flows out through the downward inclining communication hole 34 to the outside of the upper casing member 1a. As communication hole 34 is also provided for annular airspace 24 of female rotor side and the annular airspace of female rotor side is connected with the communication passage 35, even when one of the communication hole is clogged by any cause, the lubrication oil can flow out to the outside of the upper casing member 1a through the other communication hole.

Shaft sealing structure and its action were explained above concerning those of the upper casing member side rotor shaft sealing part.

The rotor shaft sealing parts of the lower casing member side bearing part corresponding to those of the upper casing member side bearing part are designated by reference numerals affixed with ′mark, and the structure is similar to that of the upper casing member side rotor shaft sealing parts except that the communication holes 34′ of the lower casing member 1b are opened to atmosphere and that the viscoseal is composed to force the lubrication oil intruded into the viscoseal zone downward as the rotor shaft rotates.

Action of the shaft sealing structure of the lower casing member side rotor shaft sealing part is similar to that of the upper casing member side rotor shaft sealing part.

As the communication holes 34′ are opened to atmosphere, there is fear that the communication holes 34′ are clogged by dust in atmosphere, and provision of a communication holes 37′ larger in diameter is particularly preferable.

In the foregoing, an example that the rotary compressor is installed so that the rotor shafts extend vertically is explained. The invention is applicable when the rotary compressor is installed so that the rotor shafts 6, 7 extend horizontally. In this case, it is preferable that the communication hole 34 and 34′ are provided only to down side rotor shaft sealing parts of the casing members 1a and 1b respectively. As the annular airspaces 24 of the upper side rotor shaft sealing parts in the casing members 1a and 1b are connected to those of the lower side rotor shaft sealing parts by the communicating passages 35 respectively, lubrication oil leaked through the viscoseal zone 20 of each of the upper side rotor shaft sealing parts falls down through each communicating passage 35 to the annular airspace of each of the down side rotor shaft sealing parts, to be exhausted to outside of the casing member 1a in the driving gear room covered by the gear casing 17 and to the outside of the casing member 1b to the atmosphere respectively.

### INDUSTRIAL APPLICABILITY

According to the invention, rotor shaft sealing structure of an oil-free rotary compressor is provided, with which is reduced a risk of occurrence of lubrication oil intrusion into the compression chamber of the compressor which is liable to occur when negative pressure is produced in the compression chamber.

This application is based on, and claims priority to, Japanese Patent Application No: 2007-95582, filed on Mar. 30, 2007. The disclosure of the priority application, in its entirety, including the drawings, claims, and the specification thereof, is incorporated herein by reference.

1. A rotor shaft sealing structure of an oil-free rotary compressor having a pair of male and female rotors accommodated in a compression chamber formed by a rotor casing, each rotor having a rotor shaft extending vertically to penetrate both upper and lower walls of the rotor casing to be supported via oil lubricated bearings by both the upper and lower walls of the rotor casing, wherein
a rotor shaft sealing part comprising two shaft seal means is provided to each of rotor shaft bearing parts between the bearing and the compression chamber such that a horizontal annular airspace is formed between the shaft seal means,
at least one communicating hole for communicating each horizontal annual airspace to the outside of the rotor casing is provided such that the communicating hole opens at the lower corner or the bottom face of the horizontal annular airspace and descends toward the outer periphery of the rotor casing to open to the outside thereof, and
each of the horizontal annular airspaces of the male rotor shaft sealing parts and each of those of the female rotor shaft sealing parts are connected by a between-rotor shaft communication passage respectively.

2. A rotor shaft sealing structure according to claim 1, wherein said two shaft seal means are comprised of a contact seal located adjacent to the compression chamber and a non-contact seal located adjacent to the bearing to form said horizontal annular airspace theirbetween.

3. A rotor shaft sealing structure according to claim 2, wherein said contact seal is a carbon ring type seal and said non-contact seal is a viscoseal which works to force back lubrication oil from the bearing toward the bearing through the rotation of the rotor shaft.

4. A rotor shaft sealing structure according to claim 1, wherein at least one communicating hole larger in diameter than that of said communication hole is further provided to at least one of the horizontal annular airspaces such that the communicating hole of larger diameter opens in the horizontal annular airspace and descends toward the outer periphery of the rotor casing to open to the outside thereof.

5. A rotor shaft sealing structure of an oil-free rotary compressor having a pair of male and female rotors accommodated in a compression chamber formed by a rotor casing, each rotor having a rotor shaft extending horizontally from both right and left side faces of the rotor to penetrate both right and left side walls of the rotor casing to be supported via oil lubricated bearings by both the right and left side walls of the rotor casing, wherein
a rotor shaft sealing part comprising two shaft seal means is provided to each of rotor shaft bearing parts between the bearing and the compression chamber such that a vertical annular airspace is formed between the seal means, the shaft seal means being a viscoseal located adjacent the bearing and a contact seal located adjacent the compression chamber,
at least one communicating hole is provided to communicate the vertical annular airspace so that lubrication oil leaked to the annular airspace flows down by gravity to the outside of the rotor casing, and
each of the vertical annular airspaces of the male rotor shaft sealing parts and each of those of the female rotor shaft sealing parts are connected by a between-rotor shaft communication passage respectively.

6. A rotor shaft sealing structure according to claim 5, wherein at least one communicating hole larger in diameter than that of said communication hole is further provided to at least one of the vertical annular airspaces such that the communicating hole of larger diameter opens in the vertical annular airspace and descends toward the outer periphery of the rotor casing to open to the outside thereof.
